(19) United States
(12) Patent Application Publication
(10) Pub. No.: US 2023/0249588 A1
(43) Pub. Date: Aug. 10, 2023

(54) VEHICLE SEAT ADJUSTMENT SYSTEM AND METHOD

(71) Applicant: Matthew Bayes, Medicine Hat (CA)

(72) Inventor: Matthew Bayes, Medicine Hat (CA)

(21) Appl. No.: 17/668,611

(22) Filed: Feb. 10, 2022

(51) Int. Cl. B60N 2/02

(52) U.S. Cl. CPC B60N 2/0248; B60K 35/00

(57) ABSTRACT

A system and method are disclosed herein. The system includes a user interface and a control unit. The user interface preferably includes a touchscreen and a fingerprint sensor. The control unit is in communication with a drive means attached to at least one seat in a vehicle. The system is configured to save seat positions/configurations for one or more users of a vehicle. In some embodiments, use of the system is limited to authorized users. As such, the system is configured to receive a password or a fingerprint scan from a user. Once authorized, the user selects which seat they would like to move, and the drive means in communication with the seat moves the seat to a saved seat position.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of vehicle seats of existing art and more specifically relates to a system and method for adjusting and saving positions of vehicle seats for multiple users.

### RELATED ART

In today's market, motor vehicle innovation is focused predominantly on the aesthetics of the vehicle and on improving comfort to the driver and passengers of the vehicle. One such comfort providing innovation brought the ability to adjust seats of the vehicle. For example, in many vehicles, the seats may be adjusted backwards and forwards, a height of the seat may be adjusted, a height of a headrest may be adjusted, etc. Traditionally, these adjustments were (and in some vehicles still are) made manually, requiring the driver/passenger to make the adjustments themselves by pulling on levers, pushing/pulling parts of the seat, etc.

Currently, many vehicles now include power adjustment means utilizing electricity to make the seat adjustments. These power adjustment means improved greatly on manual adjustments means; however, problems still persist with seats/seat adjustment means available on the market and in the art. Namely, if the vehicle is a shared vehicle, adjustments need to be made prior to every ride. As such, the driver in particular must spend time making the adjustments. Even with power adjustments, this can be an unnecessary waste of time. As such, a suitable solution is desired.

### SUMMARY OF THE INVENTION

In view of the foregoing disadvantages inherent in the known vehicle seat adjustment art, the present disclosure provides a novel vehicle seat adjustment system and method. The general purpose of the present disclosure, which will be described subsequently in greater detail, is to provide a system and method that allows a plurality of users to save preferred position(s) of a driver seat and/or at least one passenger seat. The system then selectively adjusts the driver seat and/or the at least one passenger seat to the preferred position(s).

A system for automatically adjusting at least one seat in a vehicle is disclosed herein. The at least one seat including at least one drive means configured to adjust a position of at least a portion of the at least one seat. The system may include a user interface and a control unit. The user interface may include a display screen and an input means. The input means may be configured to receive input from at least one user. The control unit may be in communication with the at least one drive means and the user interface. The control unit may include a memory and a processor. The memory may be configured to store position data relating to at least one preferred position of the at least a portion of the at least one seat (the at least one preferred position determined by and associated with the at least one user); and valid access data relating to the at least one user.

The processor may be configured to receive at least one access attempt from the at least one user via the user interface; compare the at least one access attempt to the valid access data stored on the memory; authorize access when a match is detected between the at least one access attempt and the valid access data; deny access when a match is not detected between the at least one access attempt and the valid access data; and wherein access authorization enables the processor to actuate the at least one drive means to automatically adjust the at least one seat according to the position data stored in the memory (associated with the at least one user).

According to another embodiment, a method for automatically adjusting at least one seat in a vehicle, is also disclosed herein. The method includes providing the system as above; storing, via the processor, position data relating to at least one preferred position of the at least a portion of the at least one seat, the at least one preferred position determined by and associated with the at least one user; storing, via the processor, valid access data relating to the at least one user to the memory; receiving, at the processor, at least one access attempt from the at least one user via the user interface; comparing, via the processor, the at least one access attempt to the valid access data stored on the memory; authorizing access, via the processor, when a match is detected between the at least one access attempt and the valid access data; denying access, via the processor, when a match is not detected between the at least one access attempt and the valid access data; and wherein access authorization enables the processor to actuate the at least one drive means to automatically adjust the at least one seat according to the position data stored in the memory.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a vehicle seat adjustment system and method, constructed and operative according to the teachings of the present disclosure.

FIG. 1 is a schematic diagram illustrating a system for automatically adjusting at least one seat in a vehicle, the system including a control unit and a user interface connected to seats in a vehicle having drive means, according to an embodiment of the present disclosure.

FIG. 2 is a schematic diagram illustrating the system connected to the drive means, the drive means configured to adjust the seats at various areas/portions thereof, according to an embodiment of the disclosure.

FIG. 3 is a schematic diagram illustrating the system in further detail, according to an embodiment of the disclosure.

FIG. 4 is a front view of the user interface, according to an exemplary embodiment of the present disclosure.

FIG. 5 is a front view of the user interface, according to an exemplary embodiment of the present disclosure.

FIG. 6 is a front view of the user interface, according to an exemplary embodiment of the present disclosure.

FIG. 7 is a flow diagram illustrating a method for automatically adjusting at least one seat in a vehicle, according to an embodiment of the present disclosure.

FIG. 8 is a flow diagram illustrating the method in further detail, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to vehicle seats and more particularly to a vehicle seat adjustment system and method. Generally, a system is disclosed that saves seat configurations/positions for one or more users of a vehicle. For example, the system may save seat configurations/positions for five users. A touch screen panel may be located on a center console of the vehicle and may operate using password protection and/or finger identification. Once a password is entered or fingerprint scanned, a user may select which seat they desire to move, and a drive means in communication with the seat may move the seat to a saved seat position. The system may be particularly useful for individuals who share vehicles. For example, spouses, partners, families, companies with fleet vehicles, etc.

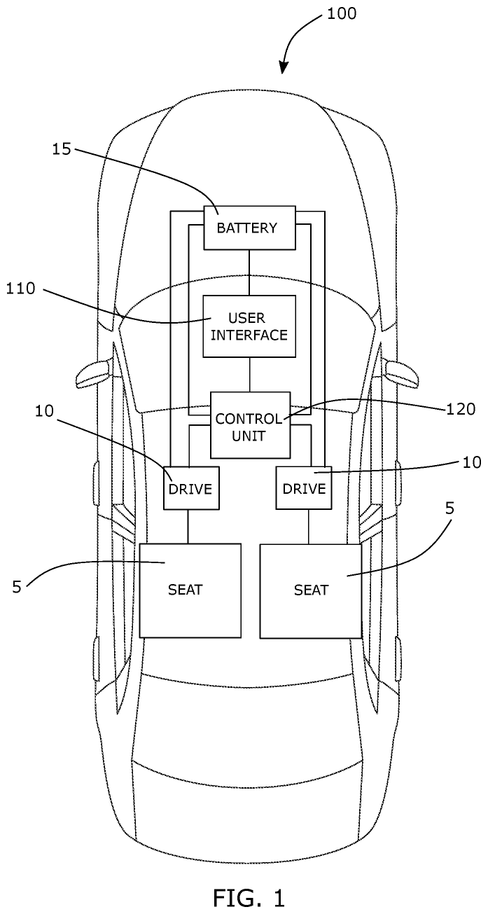

Referring now more specifically to the drawings by numerals of reference, there is shown in FIGS. 1-8, various diagrams and views of a system 100 and a method 200.

The system 100 may be configured to automatically adjust at least one seat 5 in a vehicle. For example, the at least one seat 5 may include a driver seat and at least one passenger seat (such as front passenger seat). In some embodiments, the system 100 may be configured to adjust an entirety of the at least one seat 5 (via at least one drive means 10). For example, the system 100 may adjust backward/forward position of the at least one seat 5 (lengthening or shortening leg room), may adjust a height of the at least one seat, etc.

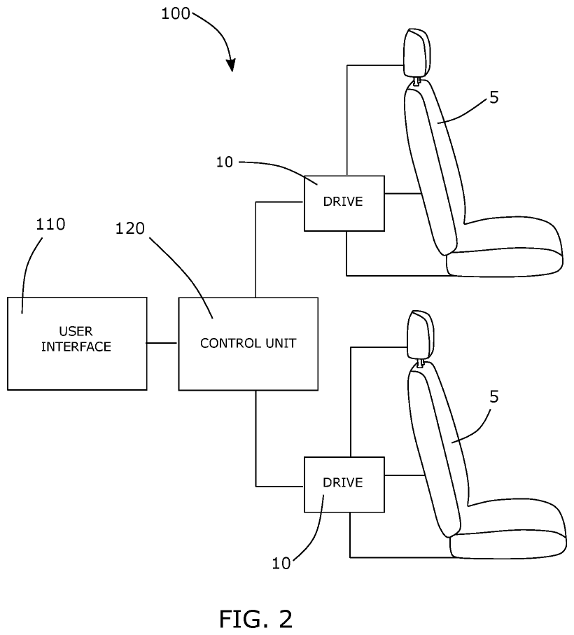

In other embodiments, the system 100 may be configured to adjust portions of the at least one seat 5. For example, the system 100 may adjust headrest angle/height/support, seat cushion angle/height, lumbar angle/height, backrest angle, etc. It should be appreciated that these areas/portions and types of adjustment are given as examples and are not meant to limit the adjustments able to be made by the system 100. FIG. 2 illustrates exemplary areas/portions of the at least one seat 5 in which the system 100 may control (backward/forward position, lumbar, headrest); however, it should be appreciated that this figure is not meant to limit the system 100 to areas/portions it may adjust on the at least one seat 5.

As shown in FIGS. 1-3, the system 100 may include a user interface 110 and a control unit 120. The at least one seat 5 may include the at least one drive means 10 configured to adjust a position of the at least a portion of the at least one seat 5. In some embodiments, the at least one drive means 10 may be existing drive means included with the vehicle. In these embodiments, the system 100 may connect to the existing at least one drive means 10. In other embodiments, the at least one drive means 10 may be included with the system 100.

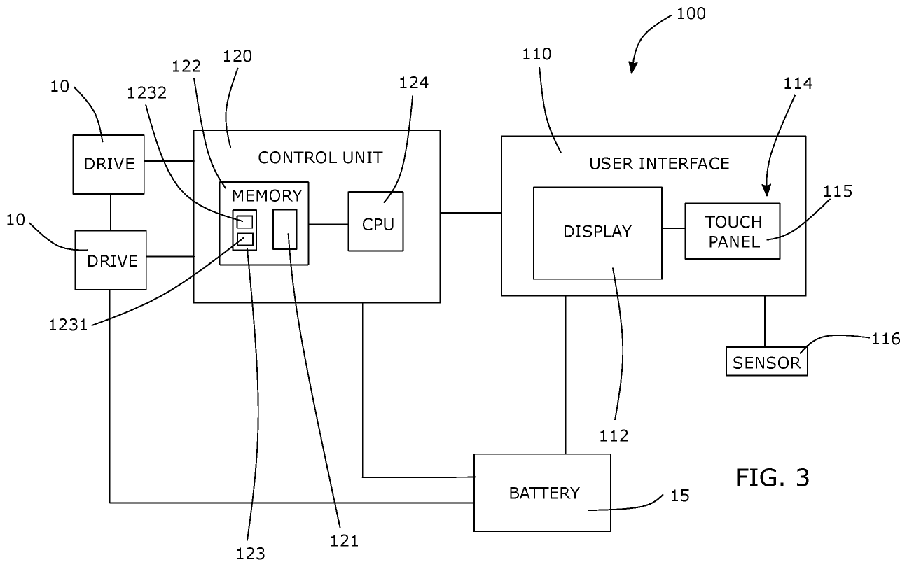

In some examples, the at least one drive means 10 may include at least one motor. Preferably, as shown in FIGS. 1-2, each seat may include drive means 10 (or a motor) attached thereto. Further, as shown in FIG. 1 and FIG. 3, in some embodiments, the system 100 may be connected with an electrical system of the vehicle. Particularly, the system 100 may receive power from a battery 15 of the vehicle. In other embodiments, a battery 15 may be provided with the system 100.

As shown in FIGS. 3-6, the user interface 110 may include a display screen 112 and an input means 114. In some examples, the display screen 112 may include a light-emitting diode (LED) display, liquid crystal display (LCD) display, or the like. In some embodiments, the user interface 110 may be included with the vehicle. For example, the user interface 110 may be integral to a center console display included with the vehicle. In other embodiments, the user interface 110 may be included with the system 100.

The input means 114 may be configured to receive input from at least one user. In some embodiments, the input means 114 may include a touch panel 115 configured to receive input from the at least one user via touch gestures on the touch panel 115. In this embodiment, the touch panel 115 and the display screen 112 may be combined to form a touchscreen.

Further, in some embodiments, the user interface 110 may include a biometric sensor. For example, the biometric sensor may include a fingerprint sensor 116. It should however be appreciated that the biometric sensor may not be limited to the fingerprint sensor 116 and that other sensors may be used instead of, or as well as, the fingerprint sensor 116. For example, the biometric sensor may include facial sensors, hand sensors, iris sensors, voice sensors, or the like.

As shown in FIGS. 1-3, the control unit 120 may be in communication with the at least one drive means 10 and the user interface 110. As shown in FIG. 3, the control unit 120 may include a memory 122 and a processor 124. It should be appreciated that the system 100 may include more than one memory 122 and more than one processor 124. The memory 122 may be configured to store position data 121 relating to at least one preferred position of the at least a portion of the at least one seat 5. The at least one preferred position is determined by and associated with the at least one user. For example, the position data 121 may include (but is not limited to) a preferred height of the at least one seat 5 as determined by the at least one user; a preferred distance between the at least one seat 5 and the dashboard/steering wheel/pedals as determined by the at least one user; and a preferred angle of the backrest as desired by the at least one user.

Preferably, the at least one user may include a plurality of users. As such, the position data 121 may relate to a plurality of preferred positions of the at least a portion of the at least one seat and each preferred position from the plurality of preferred positions may be determined by and associated with a user from the plurality of users. For example, the position data 121 may include (but is not limited to) a preferred height of the at least one seat 5 as determined by a first user, a preferred distance between the at least one seat 5 and the dashboard/steering wheel/pedals as determined by the first user, and a preferred angle of the backrest as desired by the first user; and a preferred height of the at least one seat 5 as determined by a second user, a preferred distance between the at least one seat 5 and the dashboard/steering wheel/pedals as determined by the second user, and a preferred angle of the backrest as desired by the second user. In some examples, the plurality of users may include five users. As such, the position data 121 may include the position data 121 for each of the five users and the plurality of preferred positions may include five positions (one per user) for each adjustable seat portion (headrest, height, entire seat, etc.).

Further, the memory 122 may be configured to store valid access data 123 relating to the at least one user. In some embodiments, the valid access data 123 may include at least one valid fingerprint 1232 from the at least one user. Preferably, the valid access data 123 may include at least one valid fingerprint 1232 from each of the plurality of users. For example, the valid access data 123 may include thumb print for each of the plurality of users. Where the plurality of users includes five users, the valid access data 123 may include five thumb prints. In another example, the valid access data 123 may include index finger and thumb print for each of the plurality of users. As such, where the plurality of users includes five users, the valid access data 123 may include five thumb prints and five index fingerprints.

Again, in some embodiments, the biometric sensor may include sensors other than or additional to the fingerprint sensor 116. As such, in these embodiments, the valid access data 123 may include at least one valid biometric marker of the at least one user (or the plurality of users). For example, if the biometric sensor includes an iris sensor, the valid access data 123 may include at least one valid iris pattern of the at least one user (or, again, at least one valid iris pattern for each of the plurality of users).

Further, in some embodiments, the valid access data 123 may include at least one valid password 1231 for the at least one user. For example, the at least one valid password 1231 may include numbers, letters, special characters, and/or a combination thereof, etc. Preferably, the valid access data 123 may include at least one valid password 1231 for each of the plurality of users. For example, the valid access data 123 may include one password for each of the plurality of users. The valid access data 123 and the position data 121 may be stored in the memory 122 (by the processor 124) initially at setup of the system 100 in the vehicle. For example, the user(s) may place the portion(s) of the at least one seat 5 and/or the entirety of the at least one seat 5 in their preferred position(s) and save them to the memory 122 (via the processor 124 and using the user interface 110). Further, the user(s) may create a password and/or scan their fingerprint(s) and save to the memory 122 (via the processor 124 and using the user interface 110).

The system 100 may be configured to limit access thereto to only authorized users. As such, the users may only be able to adjust the at least one seat 5 when they are authorized, for example, via fingerprint or via password. As such, the processor 124 may be configured to receive at least one access attempt from the at least one user via the user interface 110.

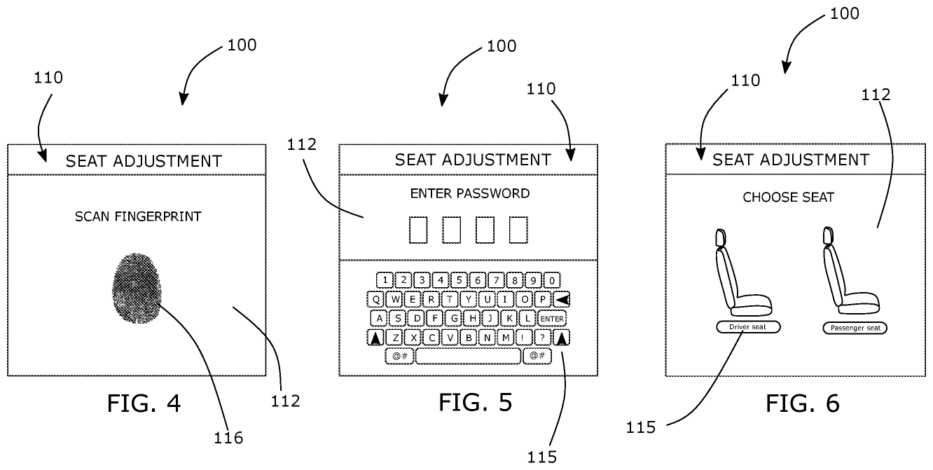

As above, the user interface 110 may include the fingerprint sensor 116 and the valid access data 123 may include at least one valid fingerprint 1232. As such, in some embodiments, as demonstrated in FIG. 4, the at least one access attempt may include a fingerprint scan from the at least one user via the fingerprint sensor 116. For example, if the at least one valid fingerprint 1232 is a print of the index finger of the at least one user, the at least one user may place their index finger over the fingerprint sensor 116. In other embodiments, as demonstrated in FIG. 5, the at least one access attempt may include a password input from the at least one user via the input means 114. This may be input via the touch panel. For example, a keyboard may be shown on the display screen 112 (or the touchscreen) for the user to input their password. It should be appreciated that FIGS. 4-5 (and FIG. 6 discussed below) are provided as examples only of what the user(s) may see when using the system 100; they are not meant to limit the user interface 110 to a particular configuration.

The processor 124 may then be configured to compare the at least one access attempt to the valid access data 123 stored on the memory 122 and either authorize access when a match is detected between the at least one access attempt and the valid access data 123 or deny access when a match is not detected between the at least one access attempt and the valid access data 123. For example, if the at least one access attempt is a fingerprint scan, the processor 124 may compare the fingerprint scan to the at least one valid fingerprint 1232 (or preferably a plurality of valid fingerprints 1232 belonging to each of the plurality of users). If the fingerprint matches, the processor 124 may authorize access.

In another example, if the at least one access attempt is a password input, the processor 124 may compare the password input to the at least one valid password 1231 (or preferably a plurality of valid passwords 1231 for each of the plurality of users). If the password matches, the processor 124 may authorize access. Access authorization may enable the processor 124 to actuate the at least one drive means 10 to automatically adjust the at least one seat 5 according to the position data 121 stored in the memory 122. For example, the at least one drive means 10 may then move the at least one seat 5 into preferred position(s) for the at least one user.

In some embodiments wherein the at least one user includes the plurality of users, the processor 124 may also be configured to receive an access attempt from one of the plurality of users, recognize the one of the plurality of users from information in the at least one access attempt (fingerprint or password unique to the one of the plurality of users), identify (specific) position data 121 relating specifically to the one of the plurality of users (their preferred positions for the at least one seat/portions of the at least one seat) and actuate the at least one drive means 10 to automatically adjust the at least one seat 5 according to the position data 121 relating specifically to the one of the plurality of users. For example, the first user may request access (by scanning their fingerprint or inputting their password) and (upon authorization from the processor 124) the at least one seat 5 may move into preferred position(s) specific to the first user.

As discussed above, the at least one seat 5 may include the driver seat and the at least one passenger seat. As such, in some embodiments, the user(s) may choose which seat they would like to control (via the system 100). In this embodiment, the processor 124 may be configured to cause the display screen 112 to display visual representations of the driver seat and the at least one passenger seat. For example, the visual representations may be images and/or indicia indicating a seat for the user(s) to select, as demonstrated in FIG. 6.

The processor 124 may be configured to receive, via the input means 114, a selection of one of the driver seat or the at least one passenger seat. For example, if using the touchscreen, the display screen 112 may display the images/indicia of the driver seat and the front passenger seat, and the user(s) may ‘tap’ or touch the driver seat to control the driver seat. Again, it should be appreciated that FIGS. 4-6 are provided as examples only of what the user(s) may see when using the system 100; they are not meant to limit the user interface 110 to a particular configuration.

The processor 124 may then be configured to actuate the at least one drive means 10 to automatically adjust the one of the driver seat or the at least one passenger seat according to the position data 121 stored in the memory 122. Using the above example, the processor 124 may then adjust position(s) of portion(s) or the entirety of the driver seat based on the saved preferred positions for the particular user (recognized by the processor 124 according to the access request—as discussed above).

It should be appreciated that the system 100 may not be limited to the adjustment and position saving of seat(s) 5. For example, the system 100 may adjust and save position data 121 relating to (but not limited to) mirrors of the vehicle (such as rear view mirror and side view mirrors); windows; steering wheel; user interface 110 arrangement or center console display arrangement (if the user interface 110 is not integral therewith), etc.

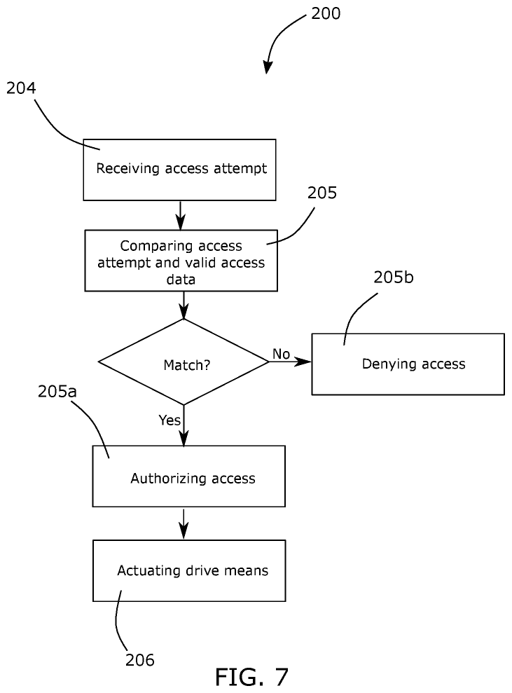

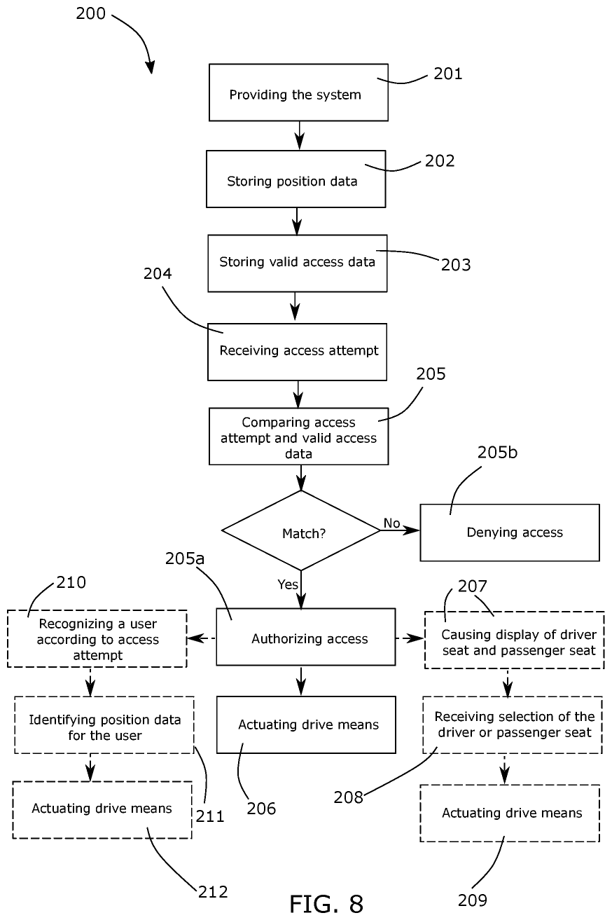

Referring specifically to FIG. 7-8 showing flow diagrams illustrating a method 200 for automatically adjusting at least one seat in a vehicle, according to an embodiment of the present disclosure. In particular, the method 200 may include one or more components or features of the system 100 as described above. As illustrated, the method 200 may include the steps of: step 201, providing the system as above; step 202, storing, via the processor, position data relating to at least one preferred position of the at least a portion of the at least one seat, the at least one preferred position determined by and associated with the at least one user; step 203, storing, via the processor, valid access data relating to the at least one user to the memory; step 204, receiving, at the processor, at least one access attempt from the at least one user via the user interface; step 205, comparing, via the processor, the at least one access attempt to the valid access data stored on the memory; step 205a, authorizing access, via the processor, when a match is detected between the at least one access attempt and the valid access data; or step 205b, denying access, via the processor, when a match is not detected between the at least one access attempt and the valid access data; and step 206 actuating, via the processor upon access authorization, the at least one drive means to automatically adjust the at least one seat according to the position data stored in the memory.

As shown in FIG. 8, wherein the at least one seat 5 includes the driver seat and the at least one passenger seat, the method 200 may further comprise the steps of: step 207, causing, via the processor, the display screen to display visual representations of the driver seat and the at least one passenger seat to the at least one user; step 208, receiving, at the processor, a selection of one of the driver seat and the at least one passenger seat from the at least one user via the input means; and step nine 209, actuating, via the processor, the at least one drive means to automatically adjust the one of the driver seat and the at least one passenger seat according to the position data stored in the memory.

Further, as shown in FIG. 8, wherein the at least one user includes the plurality of users, the step 204 of receiving the at least one access attempt may include the at least one access attempt being received (at the processor) from one of the plurality of users via the user interface. In this embodiment, the method may further comprise the steps of: step 210, recognizing, via the processor, the one of the plurality of users from information in the at least one access attempt; step eleven 211, identifying, via the processor, position data relating specifically to the one of the plurality of users; and step twelve 212, actuating, via the processor, the at least one drive means to automatically adjust the at least one seat according to the position data relating specifically to the one of the plurality of users.

It should be noted that certain steps are optional and may not be implemented in all cases. Optional steps of method 200 are illustrated using dotted lines in FIG. 8 so as to distinguish them from the other steps of method 200. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for adjusting and saving seat configurations are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A system for automatically adjusting at least one seat in a vehicle, the at least one seat including at least one drive means configured to adjust a position of at least a portion of the at least one seat, the system comprising:
a user interface including a display screen and an input means, the input means configured to receive input from at least one user;
a control unit in communication with the at least one drive means and the user interface, the control unit including:
a memory configured to:
store position data relating to at least one preferred position of the at least a portion of the at least one seat, the at least one preferred position determined by and associated with the at least one user, the memory further configured to store valid access data relating to the at least one user; and
a processor configured to:
receive at least one access attempt from the at least one user via the user interface;
compare the at least one access attempt to the valid access data stored on the memory;
authorize access when a match is detected between the at least one access attempt and the valid access data; and
deny access when a match is not detected between the at least one access attempt and the valid access data; and
wherein access authorization enables the processor to actuate the at least one drive means to automatically adjust the at least one seat according to the position data stored in the memory.

2. The system of claim 1, wherein the input means includes a touch panel configured to receive input from the at least one user via touch gestures on the touch panel.

3. The system of claim 2, wherein the user interface further includes a fingerprint sensor, wherein the valid access data includes at least one valid fingerprint of the at least one user, and wherein the at least one access attempt includes a fingerprint scan from the at least one user via the fingerprint sensor.

4. The system of claim 3, wherein the valid access data further includes at least one valid password, and wherein the at least one access attempt includes a password input from the at least one user via the input means.

5. The system of claim 4, wherein the at least one seat includes at least a driver seat and at least one passenger seat, and wherein upon access authorization, the processor is configured to:
cause the display screen to display visual representations of the driver seat and the at least one passenger seat to the at least one user;
receive, via the input means, a selection of one of the driver seat and the at least one passenger seat from the at least one user; and
actuate the at least one drive means to automatically adjust the one of the driver seat and the at least one passenger seat according to the position data stored in the memory.

6. The system of claim 5, wherein the at least one user includes a plurality of users, wherein the position data relates to a plurality of preferred positions of the at least a portion of the at least one seat, and wherein each preferred position from the plurality of preferred positions are determined by and associated with a user from the plurality of users.

7. The system of claim 6, wherein the valid access data includes at least one valid fingerprint from each of the plurality of users.

8. The system of claim 7, wherein the valid access data includes at least one valid password for each of the plurality of users.

9. The system of claim 8, wherein plurality of users includes five users.

10. The system of claim 9, wherein the processor is configured to receive the at least one access attempt from one of the plurality of users via the user interface, and wherein access authorization further enables the processor to:
recognize the one of the plurality of users from information in the at least one access attempt;
identify position data relating specifically to the one of the plurality of users; and
actuate the at least one drive means to automatically adjust the at least one seat according to the position data relating specifically to the one of the plurality of users.

11. A method for automatically adjusting at least one seat in a vehicle, the at least one seat including at least one drive means configured to adjust a position of at least a portion of the at least one seat, the method comprising:
providing a system including:
a user interface including a display screen and an input means, the input means configured to receive input from at least one user; and
a control unit in communication with the at least one drive means and the user interface, the control unit including memory and processor; and
storing, via the processor, position data relating to at least one preferred position of the at least a portion of the at least one seat, the at least one preferred position determined by and associated with the at least one user;
storing, via the processor, valid access data relating to the at least one user to the memory;
receiving, at the processor, at least one access attempt from the at least one user via the user interface;
comparing, via the processor, the at least one access attempt to the valid access data stored on the memory;
authorizing access, via the processor, when a match is detected between the at least one access attempt and the valid access data;
denying access, via the processor, when a match is not detected between the at least one access attempt and the valid access data; and
actuating, via the processor upon access authorization, the at least one drive means to automatically adjust the at least one seat according to the position data stored in the memory.

12. The method of claim 11, wherein the input means includes a touch panel configured to receive input from the at least one user via touch gestures on the touch panel.

13. The method of claim 12, wherein the user interface further includes a fingerprint sensor, wherein the valid access data includes at least one valid fingerprint of the at least one user, and wherein the at least one access attempt includes a fingerprint scan from the at least one user via the fingerprint sensor.

14. The method of claim 13, wherein the valid access data further includes at least one valid password, and wherein the at least one access attempt includes a password input from the at least one user via the input means.

15. The method of claim 14, wherein the at least one seat includes at least a driver seat and at least one passenger seat, and wherein the method further comprises the steps of:
causing, via the processor, the display screen to display visual representations of the driver seat and the at least one passenger seat to the at least one user;
receiving, at the processor, a selection of one of the driver seat and the at least one passenger seat from the at least one user via the input means; and
actuating, via the processor, the at least one drive means to automatically adjust the one of the driver seat and the at least one passenger seat according to the position data stored in the memory.

16. The method of claim 15, wherein the at least one user includes a plurality of users, wherein the position data relates to a plurality of preferred positions of the at least a portion of the at least one seat, and wherein each preferred position from the plurality of preferred positions are determined by and associated with a user from the plurality of users.

17. The method of claim 16, wherein the valid access data includes at least one valid fingerprint from each of the plurality of users.

18. The method of claim 17, wherein the valid access data includes at least one valid password for each of the plurality of users.

19. The method of claim 18, wherein the step of receiving the at least one access attempt includes the at least one access attempt being received from one of the plurality of users via the user interface, and wherein the method further comprises the steps of:
recognizing, via the processor, the one of the plurality of users from information in the at least one access attempt;
identifying, via the processor, position data relating specifically to the one of the plurality of users; and
actuating, via the processor, the at least one drive means to automatically adjust the at least one seat according to the position data relating specifically to the one of the plurality of users.

20. A system for automatically adjusting at least one of a driver seat and at least one passenger seat in a vehicle, the driver seat and the at least one passenger seat each including at least one drive means configured to adjust a position of at least a portion of the at least one of the driver seat and the at least one passenger seat, the system comprising:
a user interface including a display screen, a fingerprint sensor and a touch panel, the touch panel configured to receive input from the at least one user via touch gestures on the touch panel;
a control unit in communication with the at least one drive means and the user interface, the control unit including:
a memory configured to:
store position data relating to a plurality of preferred positions of the at least a portion of the at least one of the driver seat and the at least one passenger seat, each preferred position from the plurality of preferred positions determined by and associated with a user from a plurality of users, the memory further configured to store valid access data relating to the plurality of users, the valid access data including at least one valid fingerprint from each of the plurality of users and at least one valid password for each of the plurality of users; and
a processor configured to:
receive at least one access attempt from one of the plurality of users via the user interface, the at least one access attempt including one of a fingerprint scan from the one of the plurality of users via the fingerprint sensor and password input from the one of the plurality of users via the touch panel;
compare the at least one access attempt to the valid access data stored on the memory;
authorize access when a match is detected between the at least one access attempt and the valid access data; and
deny access when a match is not detected between the at least one access attempt and the valid access data; and
wherein access authorization enables the processor to:
recognize the one of the plurality of users from information in the at least one access attempt;
cause the display screen to display visual representations of the driver seat and the at least one passenger seat to the at least one of the plurality of users;
receive a selection of one of the driver seat and the at least one passenger seat from the at least one of the plurality of users via the touch panel;
identify position data relating specifically to the one of the plurality of users; and
actuate the at least one drive means to automatically adjust the one of the driver seat and the at least one passenger seat according to the position data relating specifically to the one of the plurality of users.
